(19) United States
(12) Patent Application Publication
(10) Pub. No.: US 2026/0264973 A1
(43) Pub. Date: Sep. 10, 2026

(54) INERT ENVIRONMENT SLEEVE ADAPTER

(71) Applicant: Western Washington University, Bellingham, WA (US)

(72) Inventor: Greg O'Neil, Bellingham, WA (US)

(73) Assignee: Western Washington University, Bellingham, WA (US)

(21) Appl. No.: 19/166,574

(22) PCT Filed: Mar. 20, 2024
(86) PCT No.: PCT/US2024/020738

§ 371 Date: Sep. 18, 2025

Related U.S. Application Data
(60) Provisional application No. 63/491,158, filed on Mar. 20, 2023.

(51) Int. Cl. B65D 85/84

(52) U.S. Cl. CPC B65D 85/84

(57) ABSTRACT

Many chemicals are sensitive to or can react with compounds in the air. For example, many chemicals can react to water vapor and oxygen as well as trace gases carbon dioxide, ammonia, and hydrogen sulfide. Chemicals are typically packaged in a container. A device, called an adapter, is presented to provide an inert environment when working with reactive chemicals. The adapter is fitted on the container and allows for the establishment of inert environment that surrounds the opening of the container.

### CROSS-REFERENCE TO RELATED APPLICATION

This application claims the benefit of U.S. Provisional Patent Application No. 63/491,158, filed Mar. 20, 2023, the contents of which is hereby incorporated by reference in its entirety.

### BACKGROUND

Many chemicals are sensitive to or can react with compounds in the air. For example, many chemicals can react to water vapor and oxygen as well as trace gases carbon dioxide, ammonia, and hydrogen sulfide. In extreme types of reactivity, some chemicals can be pyrophoric (spontaneous flammable) upon contact with the atmosphere which is very dangerous in both human and property terms. Production costs increase when chemical reagents perform unwanted reactions with the atmosphere rather than going towards the desired production product. Therefore, it is important for safety and chemistry reasons to keep such reactive chemicals separated from the atmosphere when working with chemicals that react with the atmosphere in this manner.

There are several prior art systems for providing protection for reactive chemicals from the atmosphere. The current state of the art for packaging and handling of air sensitive chemicals includes the following: (1) bottle caps with a septum built in, for example, the system sold under the Sure/Seal™ brand; (2) use of a septum for covering the opening of the container; (3) use of a combination of wax and a septum for covering the opening of the container; and (4) sealing the area between the cap and the bottle with wax and/or tape.

These prior art techniques for removal of air sensitive chemicals from its packaging vary with the type of protection from the atmosphere provided by the chemical packaging. Many of these systems provide a barrier that is placed over the opening of the container in which the reactive chemical is stored. The barrier is made of a material that can be penetrated to remove the chemical and then reseal once withdrawal of the chemical is completed.

Various problems exist with current systems used for protection of chemical substances. One main problem with current systems is that they are easily compromised; and thus, provide the outside environment access to the chemical. When reagents react with the atmosphere the result is a reduction of purity at a minimum, which can lead to reduced reaction yields, resulting in, for example, increased production costs. At a maximum access of the atmosphere to the chemical reagent raises several safety issues to both personnel and property.

### SUMMARY

The present disclosure relates to methodologies and technologies that address problems in the current state of the art or others. In accordance with an aspect of the present disclosure, an adapter is provided that is configured to provide an inert atmosphere to a space adjacent to an associated container.

In an embodiment, an adapter is provided for providing an inert atmosphere for the protection of a reactive chemical species when transferring the reactive chemical species from its storage container. The storage container may include a sealed opening and is filled with a reactive chemical species. In use, the adapter is fitted over the container in a sealing manner. Once fitted to the container, a space is formed between the upper portion of the container defining the container opening and the internal walls of the adapter. The adapter includes a gas inlet fitting connectable to a source of inert gas via a conduit, such as a tube or a hose. The space formed between the adapter and the container is filled with the inert gas in order to provide an inert atmosphere over, near, adjacent, etc., the opening of the container. The presence of the inert atmosphere provides a protective environment for the removal of the reactive chemical species from the container.

In an embodiment, an adapter for providing an inert atmosphere to a space adjacent an associated container is provided where the longitudinal axis of the container is oriented at an angle between about 0 degrees to about 45 degrees with respect to vertical. The container has an opening and contains a reactive chemical. The adapter comprises a body having a first portion and a second portion, the first portion having an opening positioned at one end of the body, the first portion configured to receive via the opening a section of the container in a sealable manner; a cavity disposed in the body and in fluid communication with the opening of the first portion, the cavity surrounding the opening of the container when the container is received by the first portion; and a gas inlet fitting disposed in fluid communication with the cavity; wherein an inert gas is introducible to the cavity through the gas inlet fitting for establishing an inert atmosphere within the cavity adjacent the opening of the container.

In any embodiment, the first portion and the second portion are made of a material that is inert or resistant to the reactive chemical.

In any embodiment, the first portion includes a material selected from the group consisting of natural rubber, butyl rubber, polyvinyl chloride, polyvinyl bromide, polyethylene, polypropylene, poly vinyl acetate, polyvinyl butyral, silicone, nitrile rubber, fluorosilicone, Teflon, polyvinyl ether, fluorinated polyvinyl ether, neoprene, styrene-butadiene rubber, EPDM (ethylene propylene diene monomer) rubber, polyacrylate, Hypalon, Viton, polyurethane, Kalrex, Aflas, fiberglass, glass, steel, copper, silver, gold, nickel, palladium, platinum, cobalt, rhodium, iridium, iron, ruthenium, osmium, chromium, molybdenum, tungsten, manganese, rhenium and combinations thereof.

In any embodiment, the second portion includes a material selected from natural rubber, butyl rubber, polyvinyl chloride, polyvinyl bromide, polyethylene, polypropylene, poly vinyl acetate, polyvinyl butyral, silicone, nitrile rubber, fluorosilicone, Teflon, polyvinyl ether, fluorinated polyvinyl ether, neoprene, styrene-butadiene rubber, EPDM (ethylene propylene diene monomer) rubber, polyacrylate, Hypalon, Viton, polyurethane, Kalrex, Aflas, fiberglass, glass, steel, copper, silver, gold, nickel, palladium, platinum, cobalt, rhodium, iridium, iron, ruthenium, osmium, chromium, molybdenum, tungsten, manganese, rhenium and combinations thereof.

In any embodiment, the material of the first portion and the material of the second portion are the same or substantially identical.

In any embodiment, the material of the first portion and material of the second portion are different.

In any embodiment, the second portion has an opening at an end thereof.

In any embodiments, the body of the adapter, the first portion of the body or the second portion of the body is cylindrical in shape.

In any embodiments, the first portion and the second portion include concentric cylinders.

In any embodiment, the first portion has a smaller diameter than the second portion, where the second portion forms at least a section of the cavity to hold the inert gas.

In any embodiment, the first portion of the body includes at least one tapering section.

In any embodiment, the second portion of the body is cylindrically shaped, and the first portion of the body includes first and second tapering sections. The first tapering section tapers inwardly from the second portion to a middle section and the second tapering section tapers outwardly from the middle section to an end that forms the opening of the first portion.

In any embodiment, the gas inlet fitting is selected the group of fittings consisting of smooth, barbed, ribbed, threaded, push, pull, straight, tapered, or combinations thereof.

In any embodiment, the gas inlet fitting is attached to a hollow ring, with the hollow ring sized and configured to be received within the cavity of the body, wherein the hollow ring includes one or more gas exits in gas communication with the gas inlet fitting.

In any embodiment, the second portion of the body includes an opening at an end of the body opposite the opening of the first portion.

In any embodiment, the opening of the first portion or the opening of the second portion has a diameter of about 0.5 inch to about 4 inches.

In any embodiment, the first portion of the body includes outer walls, wherein the outer walls have a thickness of about 0.5 mm to about 10 mm.

In any embodiment, the thickness of the outer walls is about 1 mm to about 15 mm.

In any embodiment, the inert gas is heavier than air.

In any embodiments, the inert gas is selected from the group consisting of nitrogen, helium, neon, argon, krypton, xenon, carbon dioxide, carbon disulfide, sulfur hexafluoride, methane, ethane, propane, butane, isobutane, neopentane and combinations thereof.

In accordance with another aspect of the present disclosure, a device is provided to transfer solid reactive chemicals. In an embodiment, the device may include a ring, a vessel attached to the ring, the vessel having a first opening, and a covering configured to seal the first opening of the vessel. The device is sized and configured to be insertable into the cavity of any embodiment of the adapter set forth herein.

In any embodiment, the ring is selected from a metal ring, plastic ring, rubber ring, elastomer ring, ceramic ring or combinations thereof.

In any embodiment, the vessel is selected from a beaker, cup, volumetric marked beaker, volumetric marked cup, boat, closed end tube, and combinations thereof.

In any embodiment, the vessel further includes a second opening at the bottom thereof, the second opening being selectively closed.

In any embodiment, the covering of the vessel is a stopper, a lid, a cap, a snap on lid, a snap on cap, and a film.

In any embodiment, the container houses an air reactive chemical species.

In accordance with another aspect of the present disclosure, any of the adapters disclosed herein may be used to establish an inert atmosphere that surrounds the opening of an associated container.

In accordance with another aspect of the present disclosure, a method is provided for transferring a reactive chemical. In an embodiment, the method includes obtaining a container having a sealed opening, the container housing a reactive chemical, providing an inert atmosphere surrounding the sealed opening of the container, exposing the reactive chemical to the inert atmosphere, and removing at least a portion of the reactive chemical from the container.

In any embodiment, the method may also include coupling an adapter over the opening of the container in a sealed manner, the adapter defining an interior cavity.

In any embodiments, the inert environment surrounding the sealed opening of the container is provided by filling the interior cavity with an inert gas.

In any embodiment, the inert gas is selected from a group consisting of nitrogen, helium, neon, argon, krypton, xenon, carbon dioxide, carbon disulfide, sulfur hexafluoride, methane, ethane, propane, butane, isobutane, neopentane and combinations thereof.

In any embodiment, the air reactive chemical species is selected from a group consisting of arsine, phosphine, diborane, germane, silane, dicobalt octacarbonyl, nickel carbonyl, hydrazine, diphosphane, aluminum, allium, indium, zinc, lithium, sodium, potassium, rubidium, cesium, beryllium, magnesium, calcium, strontium, barium, trimethylborane, triethylborane, butyl lithium, tert-butyl lithium, diethyl zinc, triethylaluminium, linseed oil, phosphorus, zirconium, uranium, titanium, tungsten, bismuth, hafnium, thorium, osmium, neodymium, cerium, plutonium, diethylethoxyaluminium, dichloro (methyl) silane, lithium graphite, sodium graphite, potassium graphite, sodium hydride, lithium aluminum hydride, uranium trihydride, diethylaluminium hydride, Grignard compounds, Raney nickel, palladium on carbon, iron sulfide, neptunium, and combinations thereof.

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

### DESCRIPTION OF THE DRAWINGS

The foregoing aspects and many of the attendant advantages of the claimed subject matter will become more readily appreciated as the same become better understood by reference to the following detailed description, when taken in conjunction with the accompanying drawings, wherein:

FIG. 1 illustrates one example of an adapter designed for use in transferring reactive chemicals. In this example the adapted is fitted to a bottle/container and the adapted is connected through an inlet to a gas hose.

FIG. 2 illustrates the adapter shown in FIG. 1.

FIG. 3 is an example of the adapter according to another embodiment of the present disclosure and is fitted with two inlets.

FIG. 4A illustrates a gas distribution device suitable for use with one or more embodiments of the adapter of the present disclosure.

FIG. 4B illustrates an example of the adapter with the gas distribution device shown in FIG. 4A.

FIG. 5 illustrates an example of the adapter with curvature to fit containers of reactive reagents that have contoured surfaces according to another embodiment of the present disclosure.

FIG. 6 illustrates an example of a solid materials transfer system suitable for use with any of the adapters of the present disclosure.

FIG. 7 illustrates the solid materials transfer system of FIG. 6 being fitted to a flask to transfer solid material.

FIG. 8 illustrates a container, such as a bottle, containing a reactive chemical, divalent Samarium, a highly reactive reagent in liquid form, fitted with the adapter shown in FIG. 1.

FIG. 9 illustrates a container with a samarium diiodide solution;

FIG. 10 illustrates one embodiment of the adapter attached to the top of a reagent bottle and being supplied with nitrogen gas so that the reagent contained in the bottle can be removed with a syringe without exposure to atmosphere;

FIG. 11 illustrates the reagent from FIG. 10 being transferred via syringe to a separate flask; and

FIG. 12 illustrates additional reagent can be easily transferred with no additional membrane punctures required.

### DETAILED DESCRIPTION

The detailed description set forth below in connection with the appended drawings, where like numerals reference like elements, are intended as a description of various embodiments of the present disclosure and are not intended to represent the only embodiments. Each embodiment described in this disclosure is provided merely as an example or illustration and should not be construed as preferred or advantageous over other embodiments. The illustrative examples provided herein are not intended to be exhaustive or to limit the disclosure to the precise forms disclosed. Similarly, any steps described herein may be interchangeable with other steps, or combinations of steps, in order to achieve the same or substantially similar result. Moreover, some of the method steps can be carried serially or in parallel, or in any order unless specifically expressed or understood in the context of other method steps.

Many problems exist with the current state of the art for air sensitive or toxic chemicals and their separation from the atmosphere. Methodologies and technologies are presented in this disclosure to provide an inert atmosphere for the transfer of reactive and air sensitive chemicals. These methodologies and technologies can be implemented in inexpensive, easy to use, devices that increase safety and allow for easy transfer of reactive reagents.

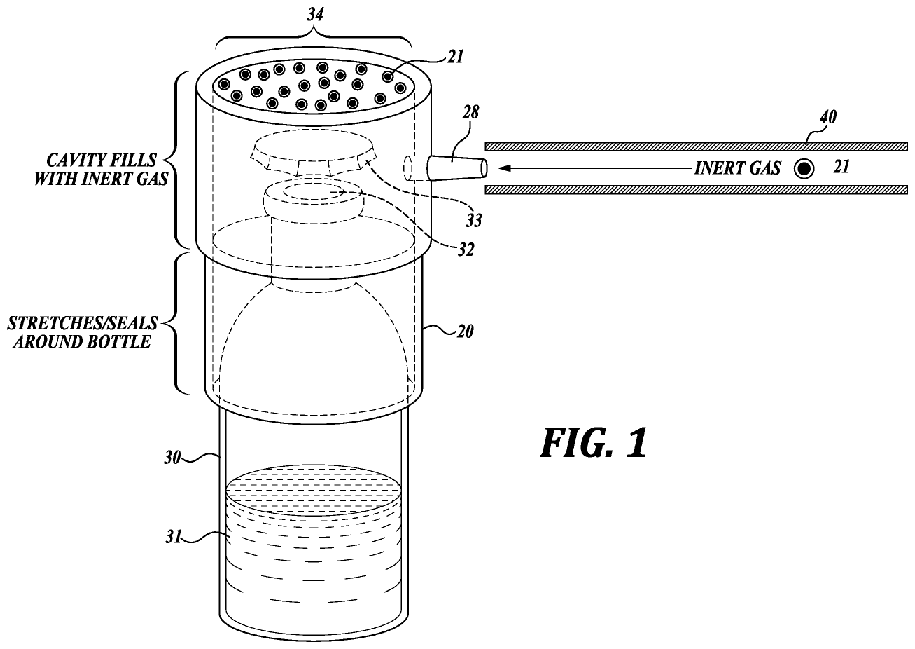

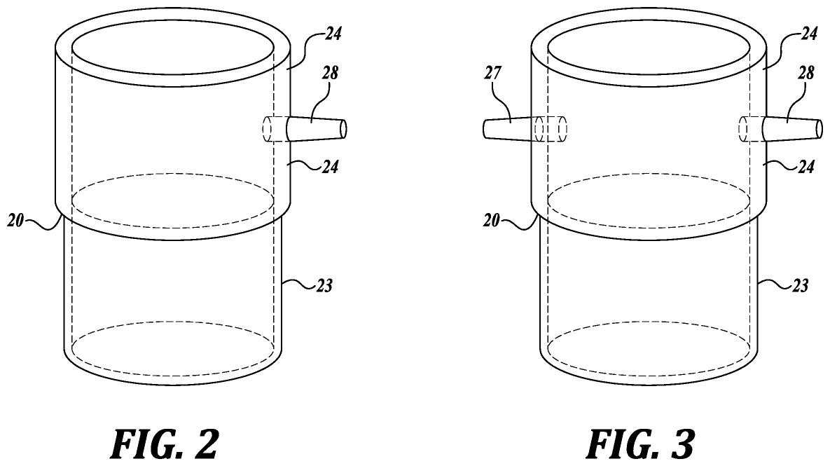

FIGS. 1 and 2 illustrates an adapter 20 designed for providing a protective environment for reactive chemicals when the reactive chemicals are removed from an associated container 30. The container 30, for example a bottle, is filled with a reactive chemical 31 and includes an opening 32 closed, for example, by a cap 33. When the cap 33 is removed the chemical 31 is exposed to the surrounding environment.

In use, the adapter 20 is fitted over the container 30 and forms a seal between the adapter 20 and the container 30. The lower portion of the adapter 23 fits snugly to the container 30 while the upper part of the adapter 24 extends above the opening 32 of the container. The top of the adapter 34 allows for easy access to the opening 32 of the container.

Once coupled to the container 30, the adapter 20 surrounds the opening 32 of the container 30, thereby forming a space between the internal walls of the adapter 20 and the upper portion of the container 30. The adapter extends above the opening 32 of the container which fills with inert gas 21 which forms a blanket over the opening 32 of the container.

Therefore, by use of the adapter 20 the reactive reagent in the container is exposed to an inert gas 21 rather than the atmosphere.

In an embodiment, the top of the adapter 20 includes an opening 34 that provides access to the opening 32 of the container 30 when the adapter 20 is coupled to the container 30. In an embodiment, the adapter opening 34 has a diameter of about 0.5 inch to about 4 inches. In another embodiment, the top of the adapter 20 may be closed to the atmosphere. In some of these embodiments, the adapter 20 may include a pressure release valve for venting pressurized gas from the space between the internal walls of the adapter 20 and the upper portion of the container 30.

The adapter 20 is made from a material that is resistant or inert to the reactive chemical 31. As shown in FIGS. 1 and 2, the adapter 20 includes a gas inlet fitting 28, a lower portion 23, and an upper portion 24. In an embodiment, the lower portion 23 is narrower than the upper portion 24. The lower portion 23 fits snugly to the container 30. The upper portion 24 extends above the container opening 32.

Still referring to FIGS. 1 and 2, the gas inlet fitting 28 is configured to attach to tubing 40, which is connected to a source of inert gas 21. The gas inlet fitting 28 is configured to introduce the inert gas 21 supplied thereto via the tubing 40 to the space formed between the internal walls of the of adapter 23, 24 that extends above of the container opening 32. As such, a blanket of inert gas 21 covers the opening of the container 32 and prevents the atmosphere from contacting with the reactive chemical 31. In some embodiments, the inert gas is heavier than air.

Once the space is filled with the inert gas, the cap 32 of the container 30 can be removed. The inert gas 21 disposed inside the adapter 20 provides a protective blanket over the container 30. With the container 30 opened under the inert gas 21, the reactive chemical 31 can be safely removed by syringe, tubing, needles, needle and syringe or other means of transfer where the means of transfer continues to protect the reactive chemical 31.

In the embodiment shown in FIG. 2, the adapter 20 is integrally formed with first and second concentric cylinders 23, 24. In some embodiments, the first or lower cylinder 23 has a smaller diameter than the second or upper cylinder 24. Of course, in other embodiments, the concentric cylinders may have the same or substantially similar diameters. In yet other embodiments, the adapter is formed by a single tube with a constant inner and/or outer diameter. As shown in FIG. 2, the gas inlet fitting 28 is mounted to the second or upper cylinder 24 of adapter 20.

The first or lower cylinder 23, or the lowermost portion of the adapter 20, is configured to fit over and form a seal with the container (see FIG. 1). In some embodiments, the first or lower cylinder 23 may be fitted over the container to a depth of about 0.5 inch to about 4 inches. In another embodiment, the depth is about is about 0.5 inches to about 6 inches. In an embodiment, the wall thickness of the first or lower cylinder 23 is about 0.5 mm to about 10 mm. In another embodiment, the wall thickness is about 1 mm to about 15 mm.

The first or lower cylinder 23, or the lower portion thereof, may be constructed of a material selected from the group consisting of natural rubber, butyl rubber, polyvinyl chloride, polyvinyl bromide, polyethylene, polypropylene, poly vinyl acetate, polyvinyl butyral, silicone, nitrile rubber, fluorosilicone, Teflon, polyvinyl ether, fluorinated polyvinyl ether, neoprene, styrene-butadiene rubber, EPDM (ethylene propylene diene monomer) rubber, polyacrylate, Hypalon, Viton, polyurethane, Kalrex, Aflas, fiberglass, glass, steel, copper, silver, gold, nickel, palladium, platinum, cobalt, rhodium, iridium, iron, ruthenium, osmium, chromium, molybdenum, tungsten, manganese, rhenium and combinations thereof.

Similarly, the second or upper cylinder 23 of adapter 20 may be constructed of a material selected from the group consisting of natural rubber, butyl rubber, polyvinyl chloride, polyvinyl bromide, polyethylene, polypropylene, poly vinyl acetate, polyvinyl butyral, silicone, nitrile rubber, fluorosilicone, Teflon, polyvinyl ether, fluorinated polyvinyl ether, neoprene, styrene-butadiene rubber, EPDM (ethylene propylene diene monomer) rubber, polyacrylate, Hypalon, Viton, polyurethane, Kalrex, Aflas, fiberglass, glass, steel, copper, silver, gold, nickel, palladium, platinum, cobalt, rhodium, iridium, iron, ruthenium, osmium, chromium, molybdenum, tungsten, manganese, rhenium and combinations thereof.

In a certain embodiment, the first cylinder 23 and the second cylinder 24 are made from the same material. Alternatively, in an embodiment, the first cylinder 23 and the second cylinder 24 of the adapter 20 are made from different materials.

In an embodiment, the inert gas 21 includes but is not limited to nitrogen, helium, neon, argon, krypton, xenon, carbon dioxide, carbon disulfide, sulfur hexafluoride, methane, ethane, propane, butane, isobutane, neopentane and combinations thereof.

In an embodiment, the reactive chemical, such as reactive chemical 31, contained in the container 30 includes but are not limited to arsine, phosphine, diborane, germane, silane, dicobalt octacarbonyl, nickel carbonyl, hydrazine, diphosphane, aluminum, allium, indium, zinc, lithium, sodium, potassium, rubidium, cesium, beryllium, magnesium, calcium, strontium, barium, trimethylborane, triethylborane, butyl lithium, tert-butyl lithium, diethyl zinc, triethylaluminium, linseed oil, phosphorus, zirconium, uranium, titanium, tungsten, bismuth, hafnium, thorium, osmium, neodymium, cerium, plutonium, diethylethoxyaluminium, dichloro(methyl) silane, lithium graphite, sodium graphite, potassium graphite, sodium hydride, lithium aluminum hydride, uranium trihydride, diethylaluminium hydride, Grignard compounds, Raney nickel, palladium on carbon, iron sulfide, neptunium, and combinations thereof.

FIG. 3 illustrates another embodiment of the adapter 20 in accordance with the present application. The adapter 20 is substantially similar in construction and operation as the adapter of FIG. 2 except for the differences that will now be described. In that regard, the adapter 20 shown in FIG. 3 includes first and second gas inlet fittings 27, 28 mounted to the second or upper cylinder 24 and configured to introduce inert gas into the interior of the adapter 20. The gas inlet fittings 27, 28 can be used to introduce the same inert gas or different inert gases into the adapter 20. In the embodiment shown, the gas inlet fittings 27 and 28 are disposed diametrically opposed from one another, although other arrangements can be employed,

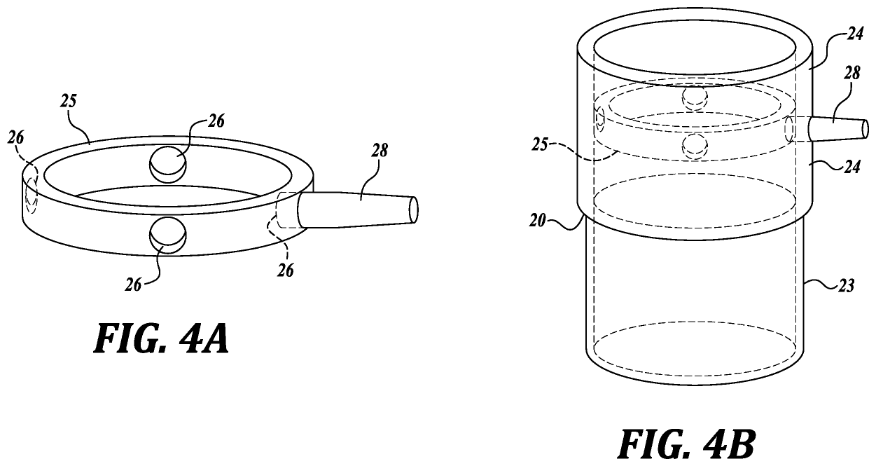

FIG. 4A illustrates a gas distribution device 25 that may be practiced with one or more embodiments of the adapter 20 described herein. As shown in FIG. 4A, the gas distribution device 25 includes a gas inlet fitting 28 that feeds inert gas to multiple inert gas exits 26. In the embodiment shown, the gas distribution device 25 includes a ring 25 with evenly spaced gas exits 26. As shown in FIG. 4B, the gas exits 26 introduce inert gas supplied to the gas inlet fitting 28 to the interior of the second or upper cylinder 24 of adapter 20.

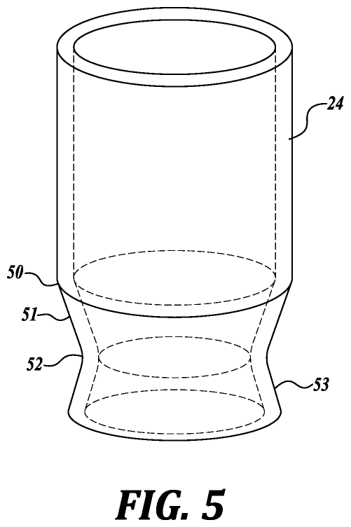

FIG. 5 illustrates another embodiment of the adapter in accordance with the present application. The adapter of FIG. 5 is substantially similar in construction and operation as the adapter of FIG. 2 except for the differences that will now be described. In that regard, instead of a lower, cylindrical portion 23, the adapter of FIG. 5 includes a lower portion 50 having a somewhat hourglass shape. In other words, the lower portion 50 includes an upper section 51 and a lower section 53, each tapering inwardly to a narrower, middle section 52. Of course, the sections 51, 52 and 53 can have any dimensions that are suitable for the particular container to which the adapter will be fitted to. While not shown for ease of illustration, the adapter of FIG. 5 may include any of the gas inlet fitting arrangements shown in FIGS. 2, 3 and 4B.

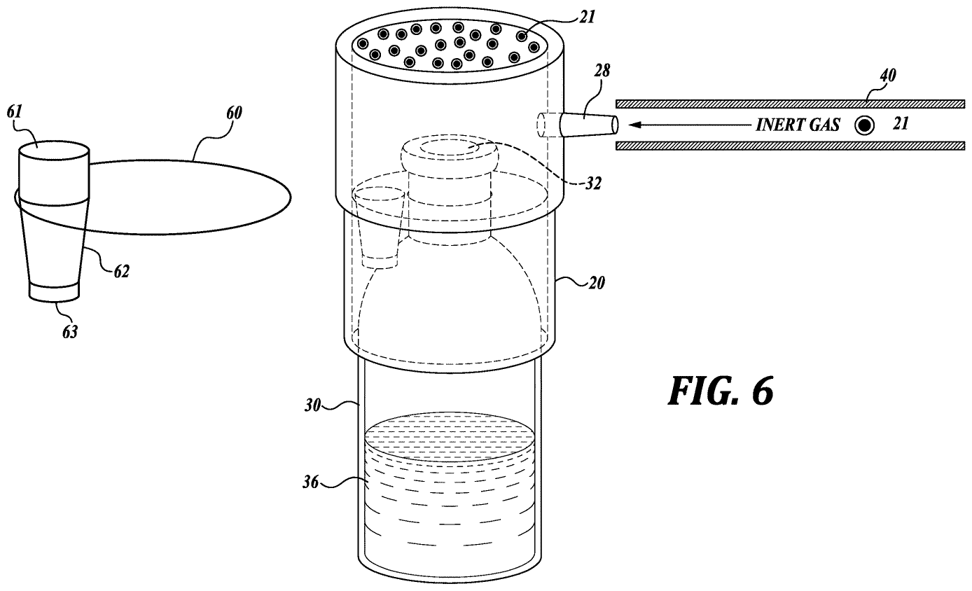

FIG. 6 illustrates a representative system for transferring solid reactive chemicals in accordance with an embodiment of the present disclosure. As shown in FIG. 6, the solid reactive chemical transfer system may be utilized with any of the adapters shown in FIGS. 2-5. In the embodiment shown, the solid reactive chemical transfer system includes a ring 60 sized and configured to fit inside the upper cylinder 24 of the adapter 20. In some embodiments, the ring 60 may include but is not limited to a metal ring, a plastic ring, a rubber ring, an elastomer ring, a ceramic ring, etc.

As shown in FIG. 6, the solid reactive chemical transfer system also includes a vessel 62 attached to the ring 60. The vessel 62 is configured to hold solid reactive chemicals. The vessel 62 is constructed of a material or materials that are non-reactive to the solid reactive chemicals transferred thereto. The vessel 62 includes an opening at its upper end. A cap or stopper 61 is provided for closing the opening of vessel 62 in a sealed manner. The bottom of vessel 62 optionally includes, for example, a hingeable bottom portion 63. In some embodiments, the vessel 62 may include but is not limited to a beaker, a cup, a volumetric marked beaker, a volumetric marked cup, a boat, a closed end tube, etc.,

In use, the tube 40 supplies inert gas to gas inlet fitting 28, and therefore, into the interior of the adapter 20. As such, inert gas 21 fills the cavity/headspace resulting from the adapter 20 fitted onto container 30. In one embodiment, this cavity can then receive the solid reactive chemical transfer system by inserting the ring 60 into the open-ended cylinder 24 and sliding the ring 60 downwardly over the neck of the container 30. Alternatively, the solid reactive chemical transfer system can be inserted into the second or upper cylinder 24 prior to fitting the adapter 20 over the container 30.

In either embodiment, the cap or stopper 61 can then be removed from the vessel 62. The container 30 is also opened in the presence of the inert atmosphere provided by the inert gas 21, which protects the solid reactive material 36 contained in the container 30. The solid material 31 can be transferred from the container 30 to the vessel 62. The vessel 62 is then capped with cap/stopper 61 and the solid reactive chemical transfer system can be removed from the adapter 20.

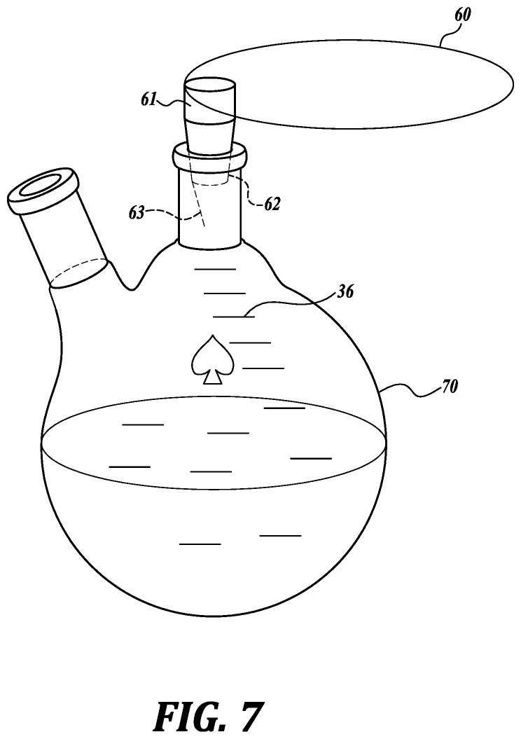

FIG. 7 illustrates one example of transferring the solid reactive chemicals contained in the vessel 62 of the solid reactive chemical transfer system of FIG. 6. The vessel 62 with cap/stopper 61 is fitted to a conventional flask 70 into which the solid reactive material 36 is to be introduced. The optional hinged bottom 63 of vessel 62 can then be opened, and the reactive solid material can fall due to gravity from vessel 62 into the flask 70.

### EXAMPLES

### Example 1

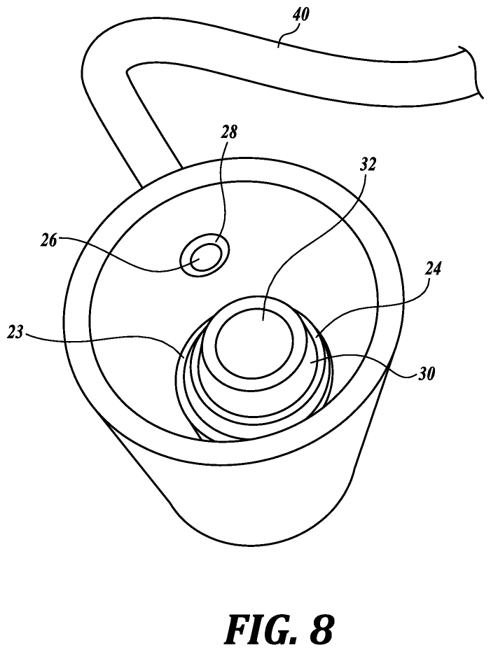

An embodiment of the adapter 20 was tested using a bottle of 1.6 M n-butyllithium, as shown in FIG. 8. n-Butyllithium is a very reactive chemical species that is pyrophoric. The adapter was fitted over the bottle and the inert gas inlet was connected to a source of nitrogen gas. The headspace formed by the cavity of the adapter over the bottle was filled with nitrogen and the cap of the container was removed. A 1 mL syringe flushed with nitrogen was filled with the n-butyllithium solution (nBuLi) by inserting a 1″ previously dried 18G needle into the opening of the bottle containing the n-butyllithium. The plunger on the syringe was slowly pulled up to fill the syringe with the 1 mL of nBuLi. The n-butyllithium concentration was monitored using titration. The titrations were performed using standard chemical methods by first drying and placing under a dry nitrogen (N2) atmosphere three (3) 15 mL vials each equipped with a 1 cm stir bar and red rubber septa (“subaseal”) using standard Schlenk techniques. To each vial was added ~1 mmol of diphenylaceticacid (DPA) followed by dry THF (8 mL). The methods as described below.

A dried vial with red septum, stir bar, DPA solution and nitrogen line was assembled. The 1 mL syringe assembly containing the nBuLi was then removed from the bottle opening and quickly inserted through a red rubber septum into the head space above the DPA solution contained in one of the 15 ml vials. The nBuLi was added dropwise to the DPA solution while stirring (~500 rpm) until a faint yellow color persisted. The volume required to generate a persistent yellow color was recorded and the procedure was repeated two more times (total=3 trials).

The results of these tests are shown in Table 1.

TABLE 1
Bottle Sleeve Adapter Titration Results
Time = 0

| | | | | Avg = |
|---|---|---|---|---|
| DPA(mg) | DPA(mmol)^{a} | nBuLi(mL) | nBuLi^{b} | 1.409M |
| 212 | 0.999 | 0.72 | 1.388 | |
| 212 | 0.994 | 0.70 | 1.420 | |
| 211 | 0.994 | 0.70 | 1.420 | |

Time = 24 h

| | | | | Avg = |
|---|---|---|---|---|
| DPA(mg) | DPA(mmol) | nBuLi(mL) | nBuLi | 1.409M |
| 213 | 1.004 | 0.70 | 1.434 | |
| 213 | 1.004 | 0.71 | 1.141 | |
| 212 | 0.999 | 0.73 | 1.368 | |

Time = 1 wk

| | | | | Avg = |
|---|---|---|---|---|
| DPA(mg) | DPA(mmol) | nBuLi(mL) | nBuLi | 1.430M |
| 213 | 1.004 | 0.69 | 1.455 | |
| 213 | 1.004 | 0.69 | 1.455 | |
| 214 | 1.008 | 0.73 | 1.381 | |

^{a}Calculated by the molecular weight (212.24 g/mol)
^{b}Calculated as mmol DPA/mL nBuLi between titrations. The bottle was stored at 4° C. with the cap sealed with Parafilm.

n-Butyllithium was initially titrated to a concentration of 1.409M. As shown in Table 1, the concentration of n-butyllithium was little changed after 24 hours with use of an adapter of the present disclosure. After one week of using the adapter, the n-butyllithium concentration was tested again. As shown in Table 1, the concentration of n-butyllithium was measured to be 1.430M after one week of using the adapter. Again, this change was negligible from the initial opening of the container. The data of Table 1 gives data that an adapter according to the methodologies and technologies of the present disclosure provides protection for pyrophoric n-butyllithium and that the concentration of n-butyllithium does not change with use of such an adapter.

### Example 2

A test was performed on samarium diiodide using an adapter 20 according to the methodologies and technologies of the present disclosure. Samarium diiodide is an extremely air-sensitive reagent. Samarium diiodide, when handled properly, forms a solution that is a bright blue color. Upon exposure to oxygen, the solution of samarium diiodide rapidly turns yellow as Sm²⁺ is oxidized to Sm³⁺ by oxygen in the atmosphere. Exposure of samarium diiodide to any quantity of atmosphere greatly diminishes desired product yields.

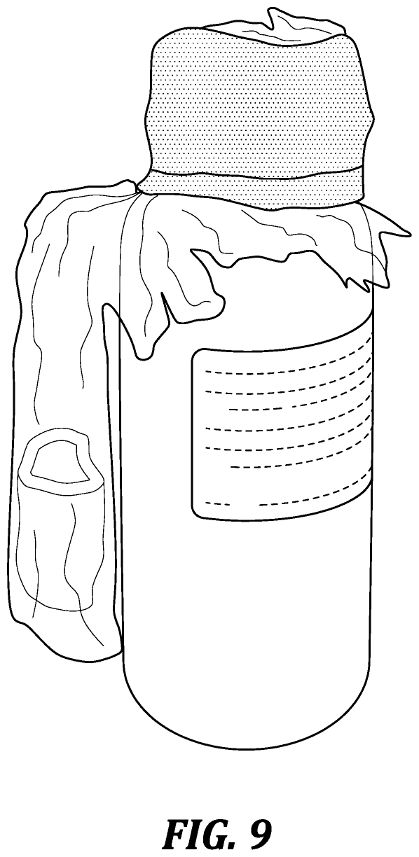

Samarium diiodide is often sold in a glass bottle. The bottle is typically not sealed so a septum is sold with the bottle, as shown in FIG. 9. This arrangement leads to reactions with poor yields and short shelf life of the reagent since once the bottle is opened oxygen enters the bottle and oxidizes the divalent samarium to trivalent.

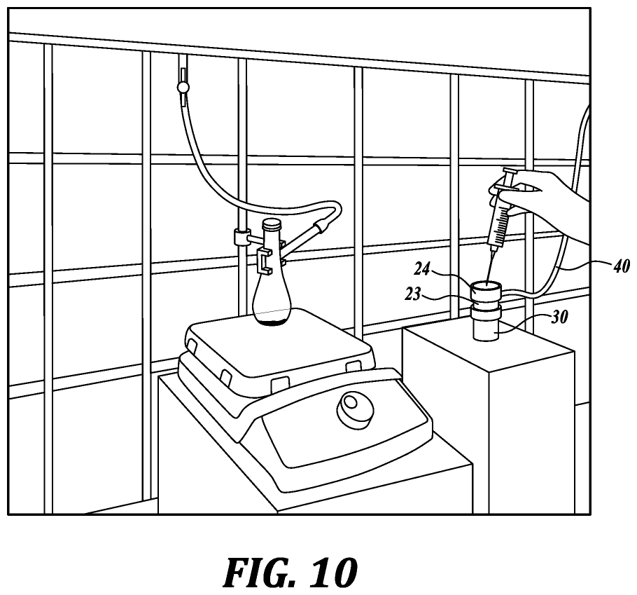

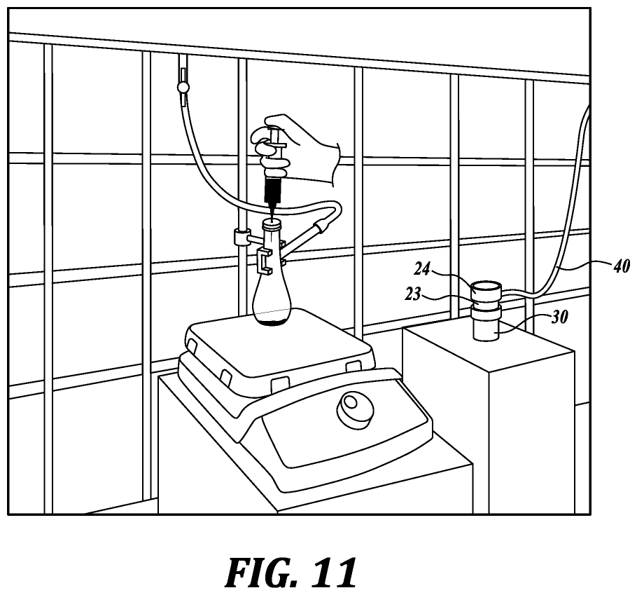

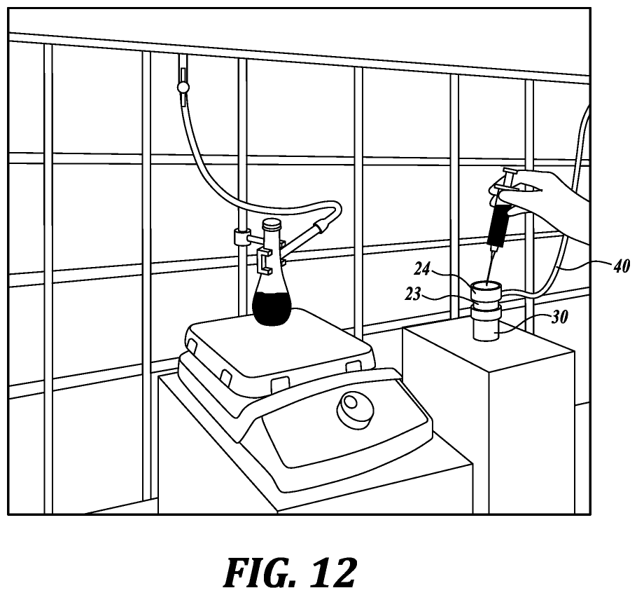

FIG. 10 illustrates the testing setup for using samarium diiodide with the adapter. The adapter 20 is fitted over the bottle containing samarium diiodide. The cavity of the adapter is then filled with nitrogen gas and the bottle of samarium diiodide is opened. A syringe with fitted needle is then used to draw the solution of samarium diiodide into the syringe. The blue color of the divalent samarium ion was observed in the syringe. Accordingly, the adapter 20 maintained a protective atmosphere for the removal of the samarium diiodide. With the use of the adapter 20, the divalent samarium can be transferred with ease to a flask, as shown in FIG. 11. Thus, a working amount of reagent can be easily, rapidly, and safely transferred, as shown in FIG. 12.

### EXAMPLE EMBODIMENTS

A collection of example embodiments, including at least some explicitly enumerated as “ECs” (Example Combinations), providing additional description of a variety of embodiment types in accordance with the concepts described herein are provided below. These examples are not meant to be mutually exclusive, exhaustive, or restrictive; and the claimed subject matter is not limited to these example embodiments but rather encompasses all possible modifications and variations within the scope of the issued claims and their equivalents.
EC A. An adapter for providing an inert atmosphere to a space adjacent an associated container. The longitudinal axis of the container is oriented at an angle between, for example, about 0 degrees to about 45 degrees with respect to vertical. The container has an opening and contains a reactive chemical. The adapter comprises: a body having a first portion and a second portion, the first portion having an opening positioned at one end of the body, the first portion configured to receive via the opening a section of the container in a sealable manner; a cavity disposed in the body and in fluid communication with the opening of the first portion, the cavity surrounding the opening of the container when the container is received by the first portion; and a gas inlet fitting disposed in fluid communication with the cavity; wherein an inert gas is introducible to the cavity through the gas inlet fitting for establishing an inert atmosphere within the cavity adjacent the opening of the container.
EC B. The adapter according to any of the preceding or subsequent example combinations, wherein the first portion and the second portion are made of a material that is inert or resistant to the reactive chemical.
EC C. The adapter according to any of the preceding or subsequent example combinations, wherein the first portion includes a material selected from the group consisting of natural rubber, butyl rubber, polyvinyl chloride, polyvinyl bromide, polyethylene, polypropylene, poly vinyl acetate, polyvinyl butyral, silicone, nitrile rubber, fluorosilicone, Teflon, polyvinyl ether, fluorinated polyvinyl ether, neoprene, styrene-butadiene rubber, EPDM (ethylene propylene diene monomer) rubber, polyacrylate, Hypalon, Viton, polyurethane, Kalrex, Aflas, fiberglass, glass, steel, copper, silver, gold, nickel, palladium, platinum, cobalt, rhodium, iridium, iron, ruthenium, osmium, chromium, molybdenum, tungsten, manganese, rhenium and combinations thereof.
EC D. The adapter according to any of the preceding or subsequent example combinations, wherein the second portion includes a material selected from natural rubber, butyl rubber, polyvinyl chloride, polyvinyl bromide, polyethylene, polypropylene, poly vinyl acetate, polyvinyl butyral, silicone, nitrile rubber, fluorosilicone, Teflon, polyvinyl ether, fluorinated polyvinyl ether, neoprene, styrene-butadiene rubber, EPDM (ethylene propylene diene monomer) rubber, polyacrylate, Hypalon, Viton, polyurethane, Kalrex, Aflas, fiberglass, glass, steel, copper, silver, gold, nickel, palladium, platinum, cobalt, rhodium, iridium, iron, ruthenium, osmium, chromium, molybdenum, tungsten, manganese, rhenium and combinations thereof.
EC E. The adapter according to any of the preceding or subsequent example combinations, wherein the material of the first portion and the material of the second portion are the same or substantially identical.
EC F. The adapter according to any of the preceding or subsequent example combinations, wherein the material of the first portion and material of the second portion are different.
EC G. The adapter according to any of the preceding or subsequent example combinations, wherein the second portion has an opening at an end thereof.
EC H. The adapter according to any of the preceding or subsequent example combinations, wherein at least one of the body, the first portion or the second portion, is cylindrical in shape.
EC I. The adapter according to any of the preceding or subsequent example combinations, wherein the first portion and the second portion are concentric cylinders.
EC J. The adapter according to any of the preceding or subsequent example combinations, wherein the first portion has a smaller diameter than the second portion, wherein the second portion forms at least a section of the cavity to hold the inert gas.
EC K. The adapter according to any of the preceding or subsequent example combinations, wherein first portion includes at least one tapering section.
EC L. The adapter according to any of the preceding or subsequent example combinations, wherein the second portion is cylindrically shaped, and the first portion includes first and second tapering sections, the first tapering section tapering inwardly from the second portion to a middle section and the second tapering section tapering outwardly from the middle section to an end that forms the opening of the first portion.
EC M. The adapter according to any of the preceding or subsequent example combinations, wherein the gas inlet fitting is selected the group of fittings consisting of smooth, barbed, ribbed, threaded, push, pull, straight, tapered, or combinations thereof.
EC N. The adapter according to any of the preceding or subsequent example combinations, wherein the gas inlet fitting is attached to a hollow ring, the hollow ring sized and configured to be received within the cavity of the body, wherein the hollow ring includes one or more gas exits in gas communication with the gas inlet fitting.
EC O. The adapter according to any of the preceding or subsequent example combinations, wherein the second portion includes an opening at an end of the body opposite the opening of the first portion.
EC P. The adapter according to any of the preceding or subsequent example combinations, wherein the opening of the first portion or the opening of the second portion has a diameter of about 0.5 inch to about 4 inches.
EC Q. The adapter according to any of the preceding or subsequent example combinations, wherein the first portion of the body includes outer walls, the outer walls having thickness of about 0.5 mm to about 10 mm.
EC R. The adapter according to any of the preceding or subsequent example combinations, wherein the thickness of the outer walls is about 1 mm to about 15 mm.
EC S. The adapter according to any of the preceding or subsequent example combinations, wherein the inert gas is heavier than air.
EC T. The adapter according to any of the preceding or subsequent example combinations, wherein the inert gas is selected from the group consisting of nitrogen, helium, neon, argon, krypton, xenon, carbon dioxide, carbon disulfide, sulfur hexafluoride, methane, ethane, propane, butane, isobutane, neopentane and combinations thereof.
EC U. A device to transfer solid reactive chemicals comprising: a ring; a vessel attached to the ring, the vessel having a first opening; a covering configured to seal the first opening of the vessel; wherein the device is sized and configured to be insertable into the cavity of any of the adapters described herein.
EC V. The device according to any of the preceding or subsequent example combinations, wherein the ring is selected from a metal ring, plastic ring, rubber ring, elastomer ring, ceramic ring or combinations thereof.
EC W. The device according to any of the preceding or subsequent example combinations, wherein the vessel is selected from a beaker, cup, volumetric marked beaker, volumetric marked cup, boat, closed end tube, and combinations thereof.
EC X. The device according to any of the preceding or subsequent example combinations, wherein the vessel further includes an second opening at the bottom thereof, the second opening being selectively closed.
EC Y. The device according to any of the preceding or subsequent example combinations, wherein the covering of the vessel is a stopper, a lid, a cap, a snap on lid, a snap on cap, and a film.
EC Z. An adapter for providing an inert atmosphere according to any of the preceding or subsequent example combinations, wherein the container houses an air reactive chemical species.
EC AA. The adapter according to any of the preceding or subsequent example combinations, wherein air reactive chemical species are selected from the group consisting of arsine, phosphine, diborane, germane, silane, dicobalt octacarbonyl, nickel carbonyl, hydrazine, diphosphane, aluminum, allium, indium, zinc, lithium, sodium, potassium, rubidium, cesium, beryllium, magnesium, calcium, strontium, barium, trimethylborane, triethylborane, butyl lithium, tert-butyl lithium, diethyl zinc, triethylaluminium, linseed oil, phosphorus, zirconium, uranium, titanium, tungsten, bismuth, hafnium, thorium, osmium, neodymium, cerium, plutonium, diethylethoxyaluminium, dichloro(methyl) silane, lithium graphite, sodium graphite, potassium graphite, sodium hydride, lithium aluminum hydride, uranium trihydride, diethylaluminium hydride, Grignard compounds, Raney nickel, palladium on carbon, iron sulfide, neptunium, and combinations thereof.
EC BB. A method of using an adapter according to any of the preceding or subsequent example combinations to establish an inert atmosphere that surrounds the opening of an associated container. The method of transferring a reactive chemical comprises: obtaining a container having a sealed opening, the container housing a reactive chemical; providing an inert atmosphere surrounding the sealed opening of the container; exposing the reactive chemical to the inert atmosphere; and removing at least a portion of the reactive chemical from the container.
EC CC. The method according to any of the preceding or subsequent example combinations, further comprising coupling an adapter over the opening of the container in a sealed manner, the adapter defining an interior cavity.
EC DD. The method according to any of the preceding or subsequent example combinations, wherein the providing an inert atmosphere surrounding the sealed opening of the container includes filling the interior cavity with an inert gas.
EC EE. The method according to any of the preceding or subsequent example combinations, wherein the inert gas is selected from a group consisting of nitrogen, helium, neon, argon, krypton, xenon, carbon dioxide, carbon disulfide, sulfur hexafluoride, methane, ethane, propane, butane, isobutane, neopentane and combinations thereof.
EC FF. The method according to any of the preceding or subsequent example combinations, wherein the reactive chemical is selected from a group consisting of arsine, phosphine, diborane, germane, silane, dicobalt octacarbonyl, nickel carbonyl, hydrazine, diphosphane, aluminum, allium, indium, zinc, lithium, sodium, potassium, rubidium, cesium, beryllium, magnesium, calcium, strontium, barium, trimethylborane, triethylborane, butyl lithium, tert-butyl lithium, diethyl zinc, triethylaluminium, linseed oil, phosphorus, zirconium, uranium, titanium, tungsten, bismuth, hafnium, thorium, osmium, neodymium, cerium, plutonium, diethylethoxyaluminium, dichloro(methyl) silane, lithium graphite, sodium graphite, potassium graphite, sodium hydride, lithium aluminum hydride, uranium trihydride, diethylaluminium hydride, Grignard compounds, Raney nickel, palladium on carbon, iron sulfide, neptunium, and combinations thereof.

In the foregoing description, specific details are set forth to provide a thorough understanding of representative embodiments of the present disclosure. It will be apparent to one skilled in the art, however, that the embodiments disclosed herein may be practiced without embodying all of the specific details. In some instances, well-known process steps have not been described in detail in order not to unnecessarily obscure various aspects of the present disclosure. Further, it will be appreciated that embodiments of the present disclosure may employ any combination of features described herein.

In the detailed description herein, references to “one embodiment”, “an embodiment”, “an example embodiment”, etc., indicate that the embodiment described may include a particular feature, structure, or characteristic, but every embodiment may not necessarily include the particular feature, structure, or characteristic. Moreover, such phrases are not necessarily referring to the same embodiment. In addition, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Thus, it will be appreciated that embodiments of the present disclosure may employ any combination of features described herein. All such combinations or sub-combinations of features are within the scope of the present disclosure.

The present application may reference quantities and numbers. Unless specifically stated, such quantities and numbers are not to be considered restrictive, but exemplary of the possible quantities or numbers associated with the present application. Also, in this regard, the present application may use the term “plurality” to reference a quantity or number. In this regard, the term “plurality” is meant to be any number that is more than one, for example, two, three, four, five, etc. The term “about,” “approximately,” etc., means plus or minus 5% of the stated value.

It should be noted that for purposes of this disclosure, terminology such as “upper,” “lower,” “vertical,” “horizontal,” “fore,” “aft,” “inner,” “outer,” “front,” “rear,” etc., should be construed as descriptive and not limiting the scope of the claimed subject matter. Further, the use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings.

Throughout this specification, terms of art may be used. These terms are to take on their ordinary meaning in the art from which they come, unless specifically defined herein or the context of their use would clearly suggest otherwise.

The drawings in the FIGURES are not to scale. Similar elements are generally denoted by similar references in the FIGURES. For the purposes of this document, the same or similar elements may bear the same references. Furthermore, the presence of reference numbers or letters in the drawings cannot be considered limiting, even when such numbers or letters are indicated in the claims.

The principles, representative embodiments, and modes of operation of the present disclosure have been described in the foregoing description. However, aspects of the present disclosure, which are intended to be protected, are not to be construed as limited to the particular embodiments disclosed. Further, the embodiments described herein are to be regarded as illustrative rather than restrictive. It will be appreciated that variations and changes may be made by others, and equivalents employed, without departing from the spirit of the present disclosure. Accordingly, it is expressly intended that all such variations, changes, and equivalents fall within the spirit and scope of the present disclosure as claimed.

1. An adapter for providing an inert atmosphere to a space adjacent an associated container, the longitudinal axis of the container oriented at an angle between about 0 degrees to about 45 degrees with respect to vertical, the container having an opening and containing a reactive chemical, the adapter comprising:
a body having a first portion and a second portion, the first portion having an opening positioned at one end of the body, the first portion configured to receive via the opening a section of the container in a sealable manner;
a cavity disposed in the body and in fluid communication with the opening of the first portion, the cavity surrounding the opening of the container when the container is received by the first portion; and
a gas inlet fitting disposed in fluid communication with the cavity;
wherein an inert gas is introducible to the cavity through the gas inlet fitting for establishing an inert atmosphere within the cavity adjacent the opening of the container.

2. The adapter according to claim 1, wherein the first portion and the second portion are made of a material that is inert or resistant to the reactive chemical.

3. The adapter according to claim 1, wherein the first portion includes a material selected from the group consisting of natural rubber, butyl rubber, polyvinyl chloride, polyvinyl bromide, polyethylene, polypropylene, poly vinyl acetate, polyvinyl butyral, silicone, nitrile rubber, fluorosilicone, Teflon, polyvinyl ether, fluorinated polyvinyl ether, neoprene, styrene-butadiene rubber, EPDM (ethylene propylene diene monomer) rubber, polyacrylate, Hypalon, Viton, polyurethane, Kalrex, Aflas, fiberglass, glass, steel, copper, silver, gold, nickel, palladium, platinum, cobalt, rhodium, iridium, iron, ruthenium, osmium, chromium, molybdenum, tungsten, manganese, rhenium and combinations thereof.

4. The adapter according to claim 1, wherein the second portion includes a material selected from natural rubber, butyl rubber, polyvinyl chloride, polyvinyl bromide, polyethylene, polypropylene, poly vinyl acetate, polyvinyl butyral, silicone, nitrile rubber, fluorosilicone, Teflon, polyvinyl ether, fluorinated polyvinyl ether, neoprene, styrene-butadiene rubber, EPDM (ethylene propylene diene monomer) rubber, polyacrylate, Hypalon, Viton, polyurethane, Kalrex, Aflas, fiberglass, glass, steel, copper, silver, gold, nickel, palladium, platinum, cobalt, rhodium, iridium, iron, ruthenium, osmium, chromium, molybdenum, tungsten, manganese, rhenium and combinations thereof.

5. The adapter according to claim 2, wherein the material of the first portion and the material of the second portion are the same or substantially identical.

6. The adapter according to claim 1, wherein the material of the first portion and material of the second portion are different.

7. The adapter according to claim 1, wherein the second portion has an opening at an end thereof.

8. The adapter according to claim 1, wherein at least one of the body, the first portion or the second portion, is cylindrical in shape.

9. The adapter according to claim 8, wherein the first portion and the second portion are concentric cylinders.

10. The adapter according to claim 9, wherein the first portion has a smaller diameter than the second portion, wherein the second portion forms at least a section of the cavity to hold the inert gas.

11. The adapter according to claim 1, wherein first portion includes at least one tapering section.

12. The adapter according to claim 11, wherein the second portion is cylindrically shaped, and the first portion includes first and second tapering sections, the first tapering section tapering inwardly from the second portion to a middle section and the second tapering section tapering outwardly from the middle section to an end that forms the opening of the first portion.

13. The adapter according to claim 1, wherein the gas inlet fitting is selected from the group of fittings consisting of smooth, barbed, ribbed, threaded, push, pull, straight, tapered, or combinations thereof.

14. The adapter according to claim 1, wherein the gas inlet fitting is attached to a hollow ring, said hollow ring sized and configured to be received within the cavity of the body, wherein said hollow ring includes one or more gas exits in gas communication with the gas inlet fitting.

15. The adapter according to claim 1, wherein the second portion includes an opening at an end of the body opposite the opening of the first portion.

16. The adapter according to claim 1, wherein the inert gas is heavier than air.

17. The adapter according to claim 1, wherein the inert gas is selected from the group consisting of nitrogen, helium, neon, argon, krypton, xenon, carbon dioxide, carbon disulfide, sulfur hexafluoride, methane, ethane, propane, butane, isobutane, neopentane and combinations thereof.

18. A device to transfer solid reactive chemicals comprising of:
a ring;
a vessel attached to said ring, the vessel having a first opening;
a covering configured to seal the first opening of said vessel;
wherein the device is sized and configured to be insertable into the cavity of the adapter of claim 1.

19-22. (canceled)

23. An adapter for providing an inert atmosphere according to claim 1, wherein the container houses an air reactive chemical species.

24. (canceled)

25. A method of transferring a reactive chemical, comprising:
obtaining a container having a sealed opening, the container housing a reactive chemical;
providing an inert atmosphere surrounding the sealed opening of the container;
exposing the reactive chemical to the inert atmosphere; and
removing at least a portion of the reactive chemical from the container.

26-29. (canceled)
